(19) United States
(12) Patent Application Publication
(10) Pub. No.: US 2020/0131431 A1
(43) Pub. Date: Apr. 30, 2020

(54) CHEMICAL ADDITIVES AND SURFACTANT COMBINATIONS FOR FAVORABLE WETTABILITY ALTERATION AND IMPROVED HYDROCARBON RECOVERY FACTORS

(71) Applicant: Alchemy Sciences, Inc., Houston, TX (US)

(72) Inventor: James P. Russum, Sugar Land, TX (US)

(21) Appl. No.: 16/600,251

(22) Filed: Oct. 11, 2019

Related U.S. Application Data
(60) Provisional application No. 62/751,170, filed on Oct. 26, 2018.

(51) Int. Cl. C09K 8/584

(52) U.S. Cl. CPC C09K 8/584

(57) ABSTRACT

A modified treatment fluid includes a first surfactant, wherein the first surfactant is nonionic, cationic, anionic, zwitterionic, or a combination thereof and a wettability altering additive (WEA) that includes an organic salt, an inorganic salt, urea, a urea derivative, a carbamate, ammonia, an amine, a glycol, a glycol ether, an amide, an aldehyde, or a combination thereof. The modified treatment fluid further includes a treatment fluid.

### CROSS-REFERENCE TO RELATED APPLICATIONS

This application is a nonprovisional application that claims priority from U.S. provisional application No. 62/751,170, filed Oct. 26, 2018, which is hereby incorporated by reference.

### BACKGROUND

### Field

The disclosure relates generally to the field of treatment fluids used in fracturing subterranean formations during hydrocarbon recovery. More specifically the disclosure relates to methods for altering reservoir wettability and hydrocarbon mobility with surfactants and other chemical additives used in the treatment fluids.

### Background Art

Surfactants are in wide use as enhanced recovery and flowback aids in hydrocarbon stimulation operations. These stimulation operations can include primary, secondary or tertiary recovery techniques, as well as hydraulic fracturing. Hydrocarbon recovery via the use of injected chemicals is a multivariate and complex function of several factors, among them are interfacial tension (IFT) reduction, wettability alteration, emulsion tendency, and compatibility with other fluid additives (e.g. friction reducers). Because of this complexity, it is extremely demanding for a single surfactant or mixture of surfactants to address all the governing mechanisms effectively enough to dramatically improve recovery rates. The inherent trade-offs can result in sub-optimal performance in terms of recovery uplift.

Treatment fluids include a number of components and are most often water-based. These components typically include acids, biocides, breakers, corrosion inhibitors, friction reducers, gels, iron control chemicals, oxygen scavengers, surfactants and scale inhibitors. The treatment fluid in combination with the hydrocarbon may flow from the matrix to the fracture network. The treatment fluid and hydrocarbons may then flow from the fracture network to the wellbore.

### SUMMARY

A modified treatment fluid is disclosed. The modified treatment fluid includes a first surfactant, wherein the first surfactant is nonionic, cationic, anionic, zwitterionic, or a combination thereof and a wettability altering additive (WEA) that includes an organic salt, an inorganic salt, urea, a urea derivative, a carbamate, ammonia, an amine, a glycol, a glycol ether, an amide, an aldehyde, or a combination thereof. The modified treatment fluid further includes a treatment fluid.

A method of forming a modified treatment fluid is disclosed. The method includes combining a first surfactant, wherein the first surfactant is nonionic, cationic, anionic, zwitterionic, or a combination thereof with a wettability altering additive (WEA), wherein the WEA is an additive or additives that alters the wetted state of a reservoir from oil-wet or weakly oil-wet to water-wet or weakly water-wet, and a treatment fluid.

A method of recovering oil from a formation is disclosed. The method includes forming a modified treatment fluid, wherein the modified treatment fluid comprises a wettability altering additive (WEA), a first surfactant, and a treatment fluid. The method also includes introducing the modified treatment fluid into at least a portion of a subterranean reservoir.

A method for hydraulic fracturing is disclosed. The method includes injecting a first amount of treatment fluid into a well without proppant, wherein the treatment fluid does not include proppant to initiate and propagate a fracture from the well while injecting a wettability altering additive (WEA) to form a treatment fluid/WEA blend. The WEA includes an organic salt, an inorganic salt, urea, a urea derivative, a carbamate, ammonia, an amine, a glycol, a glycol ether, an amide, an aldehyde, or a combination thereof. The method also includes adding proppant to the treatment fluid/WEA/blend and injecting a second amount of treatment fluid into the well while injecting a surfactant, wherein the surfactant is nonionic, cationic, anionic, zwitterionic, or a combination thereof, to form a modified treatment fluid within the well. In addition, the method includes releasing the modified treatment fluid, formation water, and hydrocarbon into the well.

A method for hydraulic fracturing is disclosed. The method includes injecting a first amount of treatment fluid, a wettability altering additive (WEA), and a surfactant into a well. The WEA includes an organic salt, an inorganic salt, urea, a urea derivative, a carbamate, ammonia, an amine, a glycol, a glycol ether, an amide, an aldehyde, or a combination thereof. The surfactant is nonionic, cationic, anionic, zwitterionic, or a combination thereof. The treatment fluid does not include proppant. The treatment fluid, WEA, and surfactant are used to initiate and propagate a fracture from the well. The method also as a second step adding a proppant to the first amount of treatment fluid together with additional WEA and surfactant. The method further includes as a third step injecting a second amount of treatment fluid, additional WEA, and additional surfactant. The method also includes as a fourth step releasing the treatment fluid, WEA, surfactant, formation water, and hydrocarbon into the well.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily reduced for clarity of discussion.

FIGS. 1A and 1B are depictions of the pore surfaces, with oil and brine layer, in a hydrocarbon reservoir.

FIG. 2 is a depiction of the proposed mechanism of oil recovery with altered wettability.

FIG. 3 is a graph consistent with the Example depicting percentage oil recovery versus time.

### DETAILED DESCRIPTION

The following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

This disclosure is not limited to the embodiments, versions, or examples described, which are included to enable a person having ordinary skill in the art to make and use the disclosed subject matter when the information contained herein is combined with existing information and technology.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations. For example, if the detailed description recites a range of from 1 to 5, that range includes all iterative ranges within that range including, for instance, 1.3-2.7 or 4.9-4.95.

As used herein, the term “hydrocarbon stimulation techniques” means methods of improving the flow of hydrocarbons out of subterranean formations. Certain hydrocarbon stimulation techniques may be commonly referred to as well interventions. In some embodiments, hydrocarbon stimulation techniques include, but are not limited to, hydraulic fracturing, water flooding, huff and puff cyclic gas injection, wellbore cleanouts, well workovers, re-pressurization (protection fracs), infill drilling, and refracturing operations.

Wettability alteration, from oil-wet to water-wet, is a factor in releasing hydrocarbons from many types of reservoirs. While surfactants can alter the formation wettability, other chemical species may be more effective for this aspect of hydrocarbon release. When combined with surfactants, such species affect wettability alteration, while freeing up the surfactants to influence other mechanisms, e.g. interfacial tension reduction.

The present disclosure is directed to a mixture of at least one surfactant and one wettability altering additive (WEA) that is combined with treatment fluid to form a modified treatment fluid and injected into a subterranean formation. The surfactant may include a mixture of surfactants that lower the interfacial tension of the hydrocarbon/brine phases and provide emulsification to help mobilize the hydrocarbon that is freed from the reservoir. The WEA may include a small, mobile molecule with a low affinity for oil and an affinity for the surface of the reservoir. Other additives suitable for use in the particular application may be included in the treatment fluids as well.

As used herein, the term “WEA” refers to an additive or additives that may be included in treatment fluids to alter the wetted state of a reservoir from oil-wet or weakly oil-wet to water-wet or weakly water-wet.

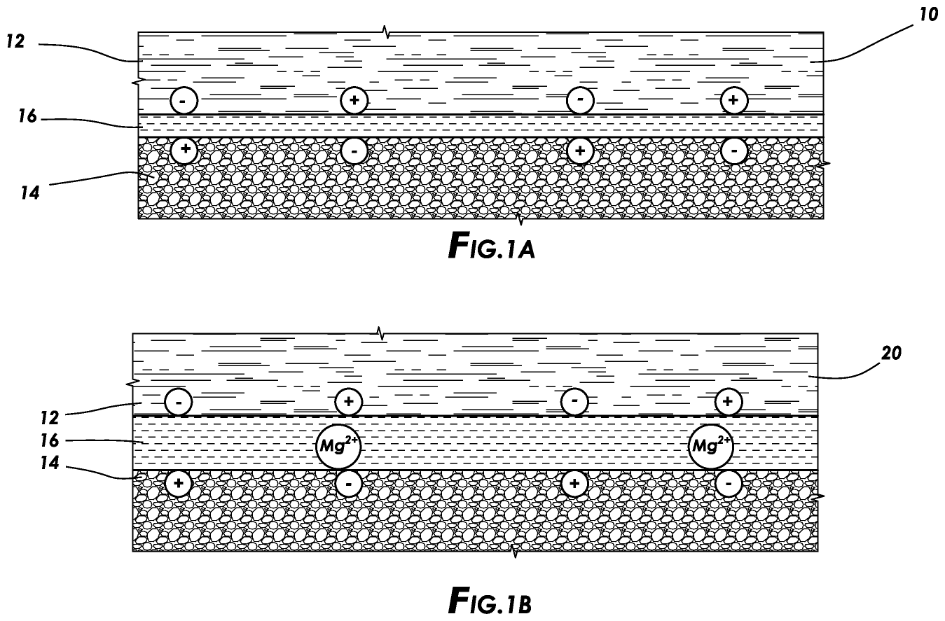

Without being bound by theory, it is believed that the small, mobile and lipophobic nature of the WEAs in the present disclosure allow the WEA molecules to diffuse into the thin layer of brine that is believed to exist between the oil and the rock in a hydrocarbon reservoir. FIGS. 1 and 1B depict one such mechanism. Element 10 denotes an oil reservoir having oil with carboxy acids & bases 12 separated from rock with exposed surface sites 14 by a thin brine film 16 without a WEA. Element 10 is the original oil-wet state of the pore space. In FIG. 1A, in element 10, thin brine film 16 has strong adhesion and weak disjoining pressure in light of the strong adhesion of the oil to the surface of the reservoir by electrostatic attraction between components in the oil and rock. By inclusion of the WEA (shown in FIG. 1B as Mg²⁺ ions), as shown by element 20, thin brine film 16 expands. By the process of diffusing into thin brine film 16, the WEA molecules disrupt the electrostatic attraction between the polar components in the crude oil and exposed sites on the reservoir rock. This increases the thickness of the brine layer and lowers the adhesion of the oil to the rock, thereby shifting the wettability from oil to water wet. The mechanism may also include affinity for the rock by the WEA.

The methods, compositions, and systems of the present disclosure may facilitate the evaluation and/or selection of additives for use in improving recovery factors from subterranean hydrocarbon formations. These methods may be particularly advantageous in unconventional reservoirs such as shale and/or tight gas formations, where stimulation and enhanced oil recovery operations are used to facilitate the production of oil and gas. In certain embodiments, the methods and systems of the present disclosure may enable the selection of additives that will alter the wettability of rock surfaces more efficiently than other methods. By focusing on additives that interact strongly with the reservoir, surfactants may be selected that target hydrocarbon mobility via emulsification and favorable interfacial elasticity, minimizing the need for wettability alteration and the associated loss to the formation.

The WEA may be an organic and inorganic salt, urea or a urea derivative, a carbamate, ammonia, an amine, a glycol, a glycol ether, an amide, an aldehyde, or a combination thereof.

Examples of organic and inorganic salts that may be suitable for use in certain embodiments of the present disclosure include, but are not limited to ammonium salts, phosphonium salts, sodium salts, potassium salts, magnesium salts and combinations thereof. Organic and inorganic salts may be present in the modified treatment fluid from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %.

Examples of carbamates that may be suitable for use in certain embodiments of the present disclosure include, but are not limited to methyl carbamate, ethyl carbamate, butyl carbamate, ammonium carbamate, amine carbamate, alkanolamine carbamate, benzyl carbamate, phenyl carbamate, and combinations thereof. Carbamates may be present in the modified treatment fluid from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %.

Examples of urea derivatives that may be suitable for use in certain embodiments of the present disclosure include, but are not limited to methyl urea, 1-ethyl urea, 1,1-dimethyl urea, 1,3-dimethyl urea, 1,1-diethyl urea, bi(hydroymethyl) urea, urea ammonium nitrate, and combinations thereof. Urea derivatives may be present in the modified treatment fluid from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %. Urea may be present in the modified treatment fluid in a concentration of from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %.

Examples of amines that may be suitable for use in certain embodiments of the present disclosure include, but are not limited to primary amines, secondary amines, and tertiary amines. The amine may be a simple amine, a cyclic amine, or an aromatic amine. The amine may be present in the modified treatment fluid from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %. The amine may be present in the treatment fluid in a concentration of from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %.

Examples of amine salts that may be suitable for use in certain embodiments of the present disclosure include, but are not limited to Allylamine hydrochloride, 3-Bromopropylamine hydrobromide, 2-Propen-1-amine hydrochloride, 3-Chloropropylamine hydrochloride, 3-Fluoro-propylamine hydrochloride, Propylamine hydrochloride, Trimethylamine hydrochloride, 2-Propanamine hydrochloride, 1,3-Diaminopropane dihydrochloride, (±)-1,1,1-Trifluoro-2-butanamine hydrochloride, Bis(2-chloroethyl)amine hydrochloride, Cyclobutylamine hydrochloride, Cyclopropanemethylamine hydrochloride, 2-Chloro-N,N-dimethylethylamine hydrochloride, Diethylamine hydrobromide, Diethylamine hydrochloride, 2-(Ethylsulfonyl)ethanamine hydrochloride, 1,4-Diaminobutane dihydrochloride, Cystamine sulfate hydrate, 1-Bicyclo[1.1.1]pentylamine hydrochloride, 4-Ethyl-1,3-thiazol-2-amine hydrochloride hydrate, 2,5-Dichloroamylamine hydrochloride, Mechlorethamine hydrochloride, 2-Chloro-N,N-dimethylpropylamine hydrochloride, 3-Dimethylamino-1-propyl chloride hydrochloride, (2-Methoxy-1,1-dimethylethyl)amine hydrochloride, (2-Methoxybutyl)amine hydrochloride, 2-(Isopropylsulfonyl)ethanamine hydrochloride, 4-Bromobenzene-1,3-diamine dihydrochloride, 2-Chloro-p-phenylenediamine monosulfate, 1,4-Phenylenediamine dihydrochloride, m-Phenylenediamine dihydrochloride, (±)-1-(Trifluoromethyl)cyclopentanamine hydrochloride, 4-(Dimethylamino)-2-butenoic acid hydrochloride, N,N-Diallylamine hydrochloride, Tris(2-chloroethyl)amine hydrochloride, 2-Bromo-N,N-diethylethylamine hydrobromide, (1-Isopropylcyclopropyl)amine hydrochloride, (1-Propylcyclopropyl)amine hydrochloride, 2-Chloro-N,N-diethylethylamine hydrochloride, 1-(Methoxymethyl)-N-methylcyclopropanamine hydrochloride, (1,1-Dioxidotetrahydro-3-thienyl)ethylamine hydrochloride, Triethylamine hydrochloride, (1,2-Dimethylpropyl)methylamine hydrochloride, (1-Ethylbutyl)amine hydrochloride, (1-Ethylpropyl)methylamine hydrochloride, (2,2-Dimethylpropyl)methylamine hydrochloride, N-Ethylbutan-2-amine hydrochloride, (3-Methoxy-2,2-dimethylpropyl)amine hydrochloride, Hexamethylenediamine dihydrochloride, Triethylenetetramine dihydrochloride, Triethylenetetramine tetrahydrochloride, 4-(Trifluoromethyl)aniline hydrochloride, 5-Bromo-2-fluorobenzylamine hydrochloride, 2-Bromobenzylamine hydrochloride, 3-Bromobenzylamine hydrochloride, 4-Bromobenzylamine hydrochloride, 6-Chloro-m-anisidine hydrochloride, (2,4-Dichloro-3-methylphenyl)amine hydrochloride, 3-Iodobenzylamine hydrochloride, 2-Nitrobenzylamine hydrochloride, 3-Nitrobenzylamine hydrochloride, 4-Nitrobenzylamine hydrochloride, 4-Iodobenzylamine hydrochloride, Benzylamine hydrochlorid, p-Toluidine hydrochloride, 2,5-Diaminotoluene sulfate, 4-Methoxy-o-phenylenediamine dihydrochloride, 1-(2-Propyl-1,3-thiazol-4-yl)methanamine hydrochloride, 2-Aminonorbornane hydrochloride, (Cyclohex-1-en-1-ylmethyl)amine hydrochloride, (1-Isobutylcyclopropyl)amine hydrochloride, (1-tert-Butylcyclopropyl)amine hydrochloride, (Cyclopropylmethyl)isopropylamine hydrochloride, 1-(1-Isopropylcyclopropyl)methanamine hydrochloride, N-Ethylcyclopentanamine hydrochloride, (1,1,3-Trimethylbutyl)amine hydrochloride, N-Isopropyl-2-methyl-1-propanamine hydrochloride, 4-Fluorophenethylamine hydrochloride, 4-Nitrophenethylamine hydrochloride, 3-Chloro-4-methoxybenzylamine hydrochloride, 2-Phenylethylamine hydrochloride, (2-Amino-4-bromophenyl)dimethylamine hydrochloride, 2-(Methanesulfonyl)benzylamine hydrochloride, 1-[3-(Methylthio)phenyl]methanamine hydrochloride, N,N-Dimethyl-1,3-phenylenediamine dihydrochloride, N,N-Dimethyl-p-phenylenediamine sulfate salt, 1-(4-Methyl-2-propyl-1,3-thiazol-5-yl)methanamine hydrochloride, 2-(2-Isopropyl-1,3-thiazol-4-yl)ethanamine hydrochloride, (1-Cyclohex-1-en-1-ylethyl)amine hydrochloride, (1-Cyclopentylcyclopropyl)amine hydrochloride, N-Methylcycloheptanamine hydrochloride, N-Propylcyclopentanamine hydrochloride, 1-[1-(Methoxymethyl)cyclopentyl]methanamine hydrochloride, N,N-Diisopropylethylamine p-toluenesulfonate salt, 2-Ethyl-1-hexanamine hydrochloride, Tetraethylenepentamine pentahydrochlorid, 2-(Aminomethyl)-5-fluoroindole, N-Methylaniline trifluoroacetate, 3-(Trifluoromethyl)phenethylamine hydrochloride, 1-(2-Chlorophenyl)cyclopropanamine hydrochloride, 1-(3-Chlorophenyl)cyclopropanamine hydrochloride, 2-Aminoindan hydrochloride, trans-2-Phenylcyclopropylamine hydrochloride, 3,4-Methylenedioxyphenethylamine hydrochloride, p-Chloro-β-methylphenethylamine hydrochloride, 3-Chloro-4-methoxyphenethylamine hydrochloride, N-Methyl-4-nitrophenethylamine hydrochloride, 2,4-Dimethoxybenzylamine hydrochloride, 4-(Dimethylamino)benzylamine dihydrochloride, 2-(2-Methoxyphenoxy)ethanamine hydrochloride hydrate, (1-Cyclohexylcyclopropyl)amine hydrochloride, 1-(2-Phenyl-1,3-oxazol-4-yl)methanamine hydrochloride, (3-Chlorobenzyl)cyclopropylamine hydrochloride, 1-(4-Chlorobenzyl)cyclopropanamine hydrochloride, 1,2,3,4-Tetrahydro-1-naphthylamine hydrochloride, 1-(2-Methylphenyl)cyclopropanamine hydrochloride, 1-(4-Methylphenyl)cyclopropanamine hydrochloride, 2,3-Dihydro-1H-inden-2-yl(methyl)amine hydrochloride, N-Benzyl-2-propen-1-amine hydrochloride, (3,4-Dihydro-2H-chromen-6-ylmethyl)amine hydrochloride, 4-Nitro-N-propylbenzylamine hydrochlorid, 1-Phenyl-2-butanamine hydrochloride, N,N-Dimethyl-1-phenyl-2-ethanamine hydrochloride, 2,4,6-Trimethoxybenzylamine hydrochloride, (1-Phenylbutyl)amine hydrochloride, 1-(4-Ethylphenyl)ethanamine hydrochloride, 1-(4-Methoxyphenyl)-N-methylethanamine hydrochloride, N-Ethyl-2-phenoxyethanamine hydrochloride, N,N,N′,N′-Tetramethyl-p-phenylenediamine dihydrochloride, N,N-Diethyl-p-phenylenediamine sulfate salt, 2-Adamantylamine hydrochloride, 2-(4-Phenyl-1,3-thiazol-2-yl)ethanamine hydrochloride, (2,2-Dimethyl-3,4-dihydro-2H-chromen-4-yl)amine hydrochloride, 2,4,6-Trimethylphenethylamine hydrochloride, 4-Isopropylphenethylamine hydrochloride, 1-(2,6-Dimethylphenoxy)-2-propanamine hydrochloride, Methoxyphenamine hydrochloride, 3,4-Dimethoxy-N-methylphenethylamine hydrochloride, N-Benzyl-2-methylpropan-1-amine hydrochloride, 1-(2-Propoxyphenyl)ethanamine hydrochloride, 2-(4-Ethoxyphenyl)propan-2-amine hydrochloride, N-Ethyl-N-isopropyl-p-phenylenediamine hydrochloride, 1,10-Phenanthroline monohydrochloride monohydrate, (3′-Chlorobiphenyl-3-yl)amine hydrochloride, 2-(2-Naphthyl)ethylamine hydrochloride, N-Methyl-1-naphthalenemethylamine hydrochloride, N-(1-Naphthyl)ethylenediamine dihydrochloride, 1-(1-Adamantyl)ethylamine hydrochloride, Dicyclohexylamine nitrite, 9-Aminofluorene hydrochloride, 4-Chlorobenzhydrylamine hydrochloride, Aminodiphenylmethane hydrochloride, 4-(Benzyloxy)aniline hydrochloride, (2′-Methylbiphenyl-3-yl)amine hydrochloride, 2-(1-Naphthyl)propan-2-amine hydrochloride, 1-(6-Methoxy-2-naphthyl)ethanamine hydrochloride, 2-(1-Adamantyl)propan-2-amine hydrochloride, (4-Biphenylylmethyl)methylamine hydrochloride, Bromhexine hydrochlorid, N-(2-Chloroethyl)dibenzylamine hydrochloride, 3,3′,5,5′-Tetramethylbenzidine dihydrochloride hydrate, 1-Pyrenemethylamine hydrochloride, N-Fmoc-ethylenediamine hydrobromide, Anisotropine methyl bromide, N-Fmoc-1,3-propanediamine hydrobromide, Orphenadrine hydrochloride, N,N-Dimethyl-1,4-phenylenediamine oxalate, N-Fmoc-1,4-butanediamine hydrobromide, N-Fmoc-cadaverine hydrobromide, Alverine citrate salt, N-Fmoc-1,6-hexanediamine hydrobromide, 3,4-Dibenzyloxyphenethylamine hydrochloride. The amine salt may be present in the modified treatment fluid from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %.

Examples of glycols and glycol ethers that may be suitable for use in certain embodiments of the present disclosure include, but are not limited to simple glycols, polyethylene glycols, 1,3-diols, 1,4-diols, 1,5-diols, ethylene glycol ethers, propylene glycol ethers, diethylene glycol ethers, and di-propylene glycol ethers. The glycol or glycol ether may be present in the modified treatment fluid from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %. The glycol or glycol ether may be present in the modified treatment fluid in a concentration of from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %.

Examples of amides that may be suitable for use in certain embodiments of the present disclosure include, but are not limited to organic amides, sulfonamides, or phosphoramides. The amide may be present in the modified treatment fluid from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %. The amide may be present in the modified treatment fluid in a concentration of from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %.

Examples of aldehydes that may be suitable for use in certain embodiments of the present disclosure include, but are not limited to formaldehyde, acetaldehyde, propionaldehyde, butyraldehyde, furfural, or benzaldehyde. The aldehyde may be present in the modified treatment fluid from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %. The aldehyde may be present in the modified treatment fluid in a concentration of from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %.

Surfactants used in the present mixture may include nonionic, cationic, anionic, zwitterionic (also sometimes referred to as amphoteric) surfactants, and combinations thereof. Surfactants may be present in the modified treatment fluid in a concentration of from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %.

Examples of nonionic surfactants include, but are not limited to, alcohol oxylalkylates, alkyl phenol oxylalkylates, nonionic esters such as sorbitan esters alkoxylates of sorbitan esters, castor oil alkoxylates, fatty acid alkoxylates, lauryl alcohol alkoxylates, nonylphenol alkoxylates, octylphenol alkoxylates, and tridecyl alcohol alkoxylate, derivatives thereof, and combinations thereof.

Examples of cationic surfactants include, but are not limited to, alkyl amines, alkyl amine salts, quaternary ammonium salts such as trimethyltallowammonium halides (e.g., trimethyltallowammonium chloride, trimethyltallowammonium bromide), amine oxides, alkyltrimethyl amines, triethyl amines, alkyldimethylbenzylamines, cetyltrimethylammonium bromide, alkyl dimethyl benzyl-ammonium chloride, trimethylcocoammonium chloride, derivatives thereof, and combinations thereof.

Examples of anionic surfactants include, but are not limited to, alkyl carboxylates, alkylether carboxylates, N-acylaminoacids, N-acylglutamates, N-acyl-polypeptides, alkylbenzenesulfonates, paraffinic sulfonates, α-olefinsulfonates, lignosulfates, derivatives of sulfosuccinates, polynapthylmethylsulfonates, alkyl sulfates, alkylethersulfates, C8 to C22 alkylethoxylate sulfate, alkylphenol ethoxylate sulfate (or salts thereof), monoalkylphosphates, polyalkylphosphates, fatty acids, alkali salts of fatty acids, glyceride sulfates, sodium salts of fatty acids, soaps, derivatives thereof, and combinations thereof.

Examples of amphoteric or zwitterionic surfactants include, but are not limited to, dihydroxyl alkyl glycinate, alkyl ampho acetate or propionate, alkyl betaine, alkyl amidopropyl betaine and alkylimino mono- or di-propionates derived from certain waxes, fats and oils, and combinations thereof.

In certain embodiments, the nonionic, cationic, anionic, and/or zwitterionic surfactant(s) selected according to the methods of the present disclosure may be used in combination with one or more additional surfactants, including but not limited to nonionic, cationic, anionic, and/or zwitterionic surfactant(s), and combinations thereof. The inclusion and/or selection of such surfactants may depend upon, additional experiments or tests performed to evaluate one or more properties of the surfactant and/or its interaction with rock surfaces and/or oil in the subterranean formation.

In certain embodiments of the present disclosure, one or more experimental tests may be used to evaluate the functionality of the nonionic, cationic, anionic, and/or zwitterionic surfactants and WEA combination. In certain embodiments, those tests may include, but are not limited to, water solubility tests, emulsion tendency tests, interfacial surface tension measurements, wettability via contact angle, spontaneous imbibition tests, hydrocarbon recovery tests, and adsorption tests.

The treating surfactant(s) selected according to the methods of the present disclosure may be incorporated into a treatment fluid that is introduced into at least a portion of a subterranean formation, for example, through a well bore. The treatment fluids used may include a base fluid, including aqueous base fluids, non-aqueous base fluids, and combinations thereof. Aqueous base fluids that may be suitable for use in the methods and systems of the present disclosure may include water, such as fresh water, salt water (e.g., water containing one or more salts dissolved therein), brine (e.g., saturated salt water), seawater, or any combination thereof. The aqueous fluids include one or more ionic species, such as those formed by salts dissolved in water. For example, seawater and/or produced water may comprise a variety of divalent cationic species dissolved therein. In certain embodiments, the density of the aqueous base fluid can be adjusted, for example, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of viscosifying agents, acids, and other additives included in the fluid. Non-limiting examples of non-aqueous fluids that may be suitable for use in the methods and systems of the present disclosure include, but are not limited to, oils, hydrocarbons, and organic liquids. In certain embodiments, the treatment fluid may include a mixture of one or more fluids and/or gases, including but not limited to emulsions, foams, and the like.

In certain embodiments, the treatment fluids used in the methods and systems of the present disclosure may include additives. Examples of such additives include, but are not limited to, salts, acids, proppant particulates, diverting agents, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, flocculants, additional H₂S scavengers, CO₂ scavengers, oxygen scavengers, lubricants, additional viscosifiers, breakers, weighting agents, relative permeability modifiers, resins, wetting agents, coating enhancement agents, filter cake removal agents, antifreeze agents (e.g., ethylene glycol), and combinations thereof.

Processes in which such modified treatment fluids may be used may include, but are not limited to, hydraulic fracturing treatments, enhanced oil recovery treatments (including, for instance, water flooding treatments and polymer flooding treatments), re-fracs, re-pressurization (such as parent-child well scenarios), remediations, recompletions, acidizing treatments, and drilling. In certain embodiments, the low permeability reservoir may be contacted by the modified treatment fluid, such as, for instance, introduction into a well bore that penetrates the low permeability reservoir. The modified treatment fluid may be formed in-situ or ex situ. The mixture may be formed in-situ, partially in-situ, or ex-situ.

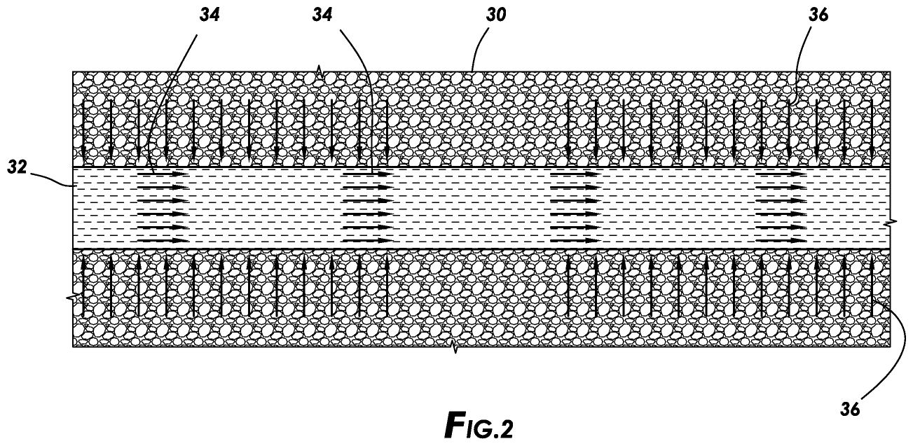

An example of a mechanism for improved recovery by using a modified treatment fluid is shown in FIG. 2. In FIG. 2, a mechanism of improved recovery via wettability alteration in a hydraulic fracturing is accomplished by using the mixture. Rock 30 is shown having hydraulic fracture with proppant 32. As shown in FIG. 2, both hydrocarbon mobility provided by the surfactant 34 and artificial permeability provided by the chemical wettability alteration 36 are improved by the mixture.

In another embodiment, a modified treatment fluid is formed in-situ. The method may use a four-step process to produce fractures in a subterranean formation while forming the modified treatment fluid. The method includes multiple stages where a portion of the well is hydraulically isolated to focus the injected treatment fluid pressure on an isolated interval, or stage. After isolating a particular stage, in the first step, a treatment fluid is injected without proppant to initiate and propagate the fracture from the well. In this embodiment, the WEA is added to the treatment fluid as the treatment fluid is injected. In the second step of the method, proppant is added to the treatment fluid/WEA blend to keep the fractures open after pumping, as the fluid pressure drops in the fractures. The fractures may be further opened in the second step. In the third step, typically referred to as the flush, treatment fluid without proppant is injected to push any remaining free proppant in the well into the fractures. In this embodiment, the surfactant (or surfactant mixture) is added to the treatment fluid/WEA in the second step to form the modified treatment fluid. Alternately, the surfactant (or surfactant mixture) may also be added to the treatment fluid during both the second and third steps. In the fourth step, called the flowback, the well is allowed to flow, thereby releasing the modified treatment fluid, formation water, and hydrocarbons. In this embodiment, a pre-defined soak time may be incorporated between the third and fourth steps.

In yet another embodiment, a modified treatment fluid is formed in-situ. In this embodiment, a four-step process is used to produce the fractures in a subterranean formation while forming the modified treatment fluid. The method includes multiple stages where a portion of the well is hydraulically isolated to focus the injected treatment fluid pressure on an isolated interval, or stage. After isolating a particular stage, in the first step, a treatment fluid is injected without proppant to initiate and propagate the fracture from the well. In the second step of the method, proppant is added to the treatment fluid to keep the fractures open after pumping, as the fluid pressure drops. The fractures may be further opened in this step. The third step, typically referred to as the flush, treatment fluid without proppant is injected to push any remaining free proppant in the well into the fractures. In this embodiment, the surfactant (or surfactant mixture) is co-injected with a WEA into the treatment fluid during in the first, second, and third steps to form the modified treatment fluid. In the fourth step, called the flowback, the well is allowed to flow, thereby releasing the modified treatment fluid, formation water, and hydrocarbons. In this embodiment, a pre-defined soak time may be incorporated between the third and fourth steps.

To facilitate a better understanding of the present disclosure, the following example of certain aspects of preferred embodiments are given. The following examples are not the only examples that could be given according to the present disclosure and are not intended to limit the scope of the disclosure or claims.

### Example

### Percentage Oil Recovery

Two control samples (Sample 1 and Sample 2) and a sample consistent with the present disclosure (Sample 3) were prepared. The percentage oil recovery was measured in a spontaneous imbibition test using non-aged (i.e. water-wet) Edwards Limestone cores with crude oil and brine at ambient conditions. The brine composition was ˜30,000 Total Dissolved Solids (TDS) in mg/L.

TABLE 1

| Sample | | | Concentration |
|---|---|---|---|
| No. | | | (ppm) |
| 1 | Surfactant 1 | 7 molar linear alcohol ethoxylate | 154 |
| | Surfactant 2 | Dodecyl benzene sulfonic acid | 77 |
| | Additive | — | 0 |
| 2 | Surfactant 1 | 7 molar linear alcohol ethoxylate | 308 |
| | Surfactant 2 | Dodecyl benzene sulfonic acid | 154 |
| | Additive | — | 0 |
| 3 | Surfactant 1 | 7 molar linear alcohol ethoxylate | 308 |
| | Surfactant 2 | Dodecyl benzene sulfonic acid | 154 |
| | Additive | Ammonium hydroxide | 50,000 |

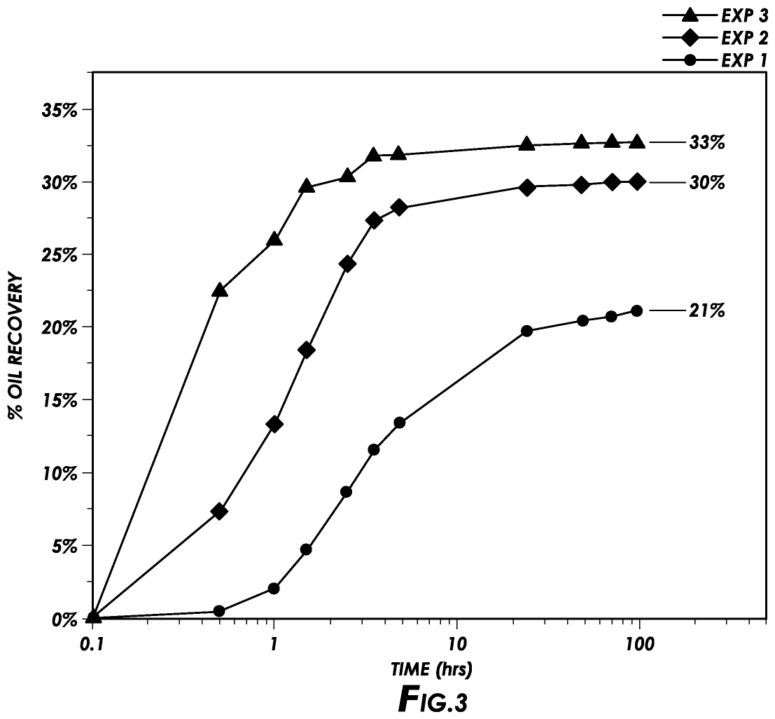

The results of the test are shown in FIG. 3. As is evident from FIG. 3, sample 3, consistent with the present disclosure, resulted in a faster oil recovery with a larger percentage of oil recovery than the two control samples.

1. A modified treatment fluid comprising:
a first surfactant, wherein the first surfactant is nonionic, cationic, anionic, zwitterionic, or a combination thereof;
a wettability altering additive (WEA) comprising an organic salt, an inorganic salt, urea, a urea derivative, a carbamate, ammonia, an amine, an amine salt, a glycol, a glycol ether, an amide, an aldehyde, or a combination thereof; and
a treatment fluid.

2. The modified treatment fluid of claim 1, wherein the WEA is an organic salt or inorganic salt selected from the group consisting of ammonium salts, phosphonium salts, sodium salts, potassium salts, magnesium salts and combinations thereof.

3. The modified treatment fluid of claim 1, wherein the WEA is a urea derivative selected from the group consisting of methyl urea, 1-ethyl urea, 1,1-dimethyl urea, 1,3-dimethyl urea, 1,1-diethyl urea, bi(hydroymethyl) urea, urea ammonium nitrate and combinations thereof.

4. The modified treatment fluid of claim 1, wherein the WEA is a carbamate selected from the group consisting of methyl carbamate, ethyl carbamate, butyl carbamate, ammonium carbamate, amine carbamate, alkanolamine carbamate, benzyl carbamate, phenyl carbamate, and combinations thereof.

5. The modified treatment fluid of claim 1, wherein the WEA is an amine selected from the group consisting of primary amines, secondary amines, and tertiary amines.

6. The modified treatment fluid of claim 5, wherein the amine is a simple amine, a cyclic amine, or an aromatic amine.

7. The modified treatment fluid of claim 1, wherein the WEA is an amine salt is selected from the group consisting of Allylamine hydrochloride, 3-Bromopropylamine hydrobromide, 2-Propen-1-amine hydrochloride, 3-Chloropropylamine hydrochloride, 3-Fluoro-propylamine hydrochloride, Propylamine hydrochloride, Trimethylamine hydrochloride, 2-Propanamine hydrochloride, 1,3-Diaminopropane dihydrochloride, (±)-1,1,1-Trifluoro-2-butanamine hydrochloride, Bis(2-chloroethyl)amine hydrochloride, Cyclobutylamine hydrochloride, Cyclopropanemethylamine hydrochloride, 2-Chloro-N,N-dimethylethylamine hydrochloride, Diethylamine hydrobromide, Diethylamine hydrochloride, 2-(Ethylsulfonyl)ethanamine hydrochloride, 1,4-Diaminobutane dihydrochloride, Cystamine sulfate hydrate, 1-Bicyclo[1.1.1]pentylamine hydrochloride, 4-Ethyl-1,3-thiazol-2-amine hydrochloride hydrate, 2,5-Dichloroamylamine hydrochloride, Mechlorethamine hydrochloride, 2-Chloro-N,N-dimethylpropylamine hydrochloride, 3-Dimethylamino-1-propyl chloride hydrochloride, (2-Methoxy-1,1-dimethylethyl)amine hydrochloride, (2-Methoxybutyl)amine hydrochloride, 2-(Isopropyl sulfonyl)ethanamine hydrochloride, 4-Bromobenzene-1,3-diamine dihydrochloride, 2-Chloro-p-phenylenediamine monosulfate, 1,4-Phenylenediamine dihydrochloride, m-Phenylenediamine dihydrochloride, (±)-1-(Trifluoromethyl)cyclopentanamine hydrochloride, 4-(Dimethylamino)-2-butenoic acid hydrochloride, N,N-Diallylamine hydrochloride, Tris(2-chloroethyl)amine hydrochloride, 2-Bromo-N,N-diethylethylamine hydrobromide, (1-Isopropylcyclopropyl)amine hydrochloride, (1-Propylcyclopropyl)amine hydrochloride, 2-Chloro-N,N-diethylethylamine hydrochloride, 1-(Methoxymethyl)-N-methylcyclopropanamine hydrochloride, (1,1-Dioxidotetrahydro-3-thienyl)ethylamine hydrochloride, Triethylamine hydrochloride, (1,2-Dimethylpropyl)methylamine hydrochloride, (1-Ethylbutyl)amine hydrochloride, (1-Ethylpropyl)methylamine hydrochloride, (2,2-Dimethylpropyl)methylamine hydrochloride, N-Ethylbutan-2-amine hydrochloride, (3-Methoxy-2,2-dimethylpropyl)amine hydrochloride, Hexamethylenediamine dihydrochloride, Triethylenetetramine dihydrochloride, Triethylenetetramine tetrahydrochloride, 4-(Trifluoromethyl)aniline hydrochloride, 5-Bromo-2-fluorobenzylamine hydrochloride, 2-Bromobenzylamine hydrochloride, 3-Bromobenzylamine hydrochloride, 4-Bromobenzylamine hydrochloride, 6-Chloro-m-anisidine hydrochloride, (2,4-Dichloro-3-methylphenyl)amine hydrochloride, 3-Iodobenzylamine hydrochloride, 2-Nitrobenzylamine hydrochloride, 3-Nitrobenzylamine hydrochloride, 4-Nitrobenzylamine hydrochloride, 4-Iodobenzylamine hydrochloride, Benzylamine hydrochlorid, p-Toluidine hydrochloride, 2,5-Diaminotoluene sulfate, 4-Methoxy-o-phenylenediamine dihydrochloride, 1-(2-Propyl-1,3-thiazol-4-yl)methanamine hydrochloride, 2-Aminonorbornane hydrochloride, (Cyclohex-1-en-1-ylmethyl)amine hydrochloride, (1-Isobutylcyclopropyl)amine hydrochloride, (1-tert-Butylcyclopropyl)amine hydrochloride, (Cyclopropylmethyl)isopropylamine hydrochloride, 1-(1-Isopropylcyclopropyl)methanamine hydrochloride, N-Ethylcyclopentanamine hydrochloride, (1,1,3-Trimethylbutyl)amine hydrochloride, N-Isopropyl-2-methyl-1-propanamine hydrochloride, 4-Fluorophenethylamine hydrochloride, 4-Nitrophenethylamine hydrochloride, 3-Chloro-4-methoxybenzylamine hydrochloride, 2-Phenylethylamine hydrochloride, (2-Amino-4-bromophenyl)dimethylamine hydrochloride, 2-(Methanesulfonyl)benzylamine hydrochloride, 1-[3-(Methylthio)phenyl]methanamine hydrochloride, N,N-Dimethyl-1,3-phenylenediamine dihydrochloride, N,N-Dimethyl-p-phenylenediamine sulfate salt, 1-(4-Methyl-2-propyl-1,3-thiazol-5-yl)methanamine hydrochloride, 2-(2-Isopropyl-1,3-thiazol-4-yl)ethanamine hydrochloride, (1-Cyclohex-1-en-1-ylethyl)amine hydrochloride, (1-Cyclopentylcyclopropyl)amine hydrochloride, N-Methylcycloheptanamine hydrochloride, N-Propylcyclopentanamine hydrochloride, 1-[1-(Methoxymethyl)cyclopentyl]methanamine hydrochloride, N,N-Diisopropylethylamine p-toluenesulfonate salt, 2-Ethyl-1-hexanamine hydrochloride, Tetraethylenepentamine pentahydrochlorid, 2-(Aminomethyl)-5-fluoroindole, N-Methylaniline trifluoroacetate, 3-(Trifluoromethyl)phenethylamine hydrochloride, 1-(2-Chlorophenyl)cyclopropanamine hydrochloride, 1-(3-Chlorophenyl)cyclopropanamine hydrochloride, 2-Aminoindan hydrochloride, trans-2-Phenylcyclopropylamine hydrochloride, 3,4-Methylenedioxyphenethylamine hydrochloride, p-Chloro-β-methylphenethylamine hydrochloride, 3-Chloro-4-methoxyphenethylamine hydrochloride, N-Methyl-4-nitrophenethylamine hydrochloride, 2,4-Dimethoxybenzylamine hydrochloride, 4-(Dimethylamino)benzylamine dihydrochloride, 2-(2-Methoxyphenoxy)ethanamine hydrochloride hydrate, (1-Cyclohexylcyclopropyl)amine hydrochloride, 1-(2-Phenyl-1,3-oxazol-4-yl)methanamine hydrochloride, (3-Chlorobenzyl)cyclopropylamine hydrochloride, 1-(4-Chlorobenzyl)cyclopropanamine hydrochloride, 1,2,3,4-Tetrahydro-1-naphthylamine hydrochloride, 1-(2-Methylphenyl)cyclopropanamine hydrochloride, 1-(4-Methylphenyl)cyclopropanamine hydrochloride, 2,3-Dihydro-1H-inden-2-yl(methyl)amine hydrochloride, N-Benzyl-2-propen-1-amine hydrochloride, (3,4-Dihydro-2H-chromen-6-ylmethyl)amine hydrochloride, 4-Nitro-N-propylbenzylamine hydrochlorid, 1-Phenyl-2-butanamine hydrochloride, N,N-Dimethyl-1-phenyl-2-ethanamine hydrochloride, 2,4,6-Trimethoxybenzylamine hydrochloride, (1-Phenylbutyl)amine hydrochloride, 1-(4-Ethylphenyl)ethanamine hydrochloride, 1-(4-Methoxyphenyl)-N-methylethanamine hydrochloride, N-Ethyl-2-phenoxyethanamine hydrochloride, N,N,N′,N′-Tetramethyl-p-phenylenediamine dihydrochloride, N,N-Diethyl-p-phenylenediamine sulfate salt, 2-Adamantylamine hydrochloride, 2-(4-Phenyl-1,3-thiazol-2-yl)ethanamine hydrochloride, (2,2-Dimethyl-3,4-dihydro-2H-chromen-4-yl)amine hydrochloride, 2,4,6-Trimethylphenethylamine hydrochloride, 4-Isopropylphenethylamine hydrochloride, 1-(2,6-Dimethylphenoxy)-2-propanamine hydrochloride, Methoxyphenamine hydrochloride, 3,4-Dimethoxy-N-methylphenethylamine hydrochloride, N-Benzyl-2-methylpropan-1-amine hydrochloride, 1-(2-Propoxyphenyl)ethanamine hydrochloride, 2-(4-Ethoxyphenyl)propan-2-amine hydrochloride, N-Ethyl-N-isopropyl-p-phenylenediamine hydrochloride, 1,10-Phenanthroline monohydrochloride monohydrate, (3′-Chlorobiphenyl-3-yl)amine hydrochloride, 2-(2-Naphthyl)ethylamine hydrochloride, N-Methyl-1-naphthalenemethylamine hydrochloride, N-(1-Naphthyl)ethylenediamine dihydrochloride, 1-(1-Adamantyl)ethylamine hydrochloride, Dicyclohexylamine nitrite, 9-Aminofluorene hydrochloride, 4-Chlorobenzhydrylamine hydrochloride, Aminodiphenylmethane hydrochloride, 4-(Benzyloxy)aniline hydrochloride, (2′-Methylbiphenyl-3-yl)amine hydrochloride, 2-(1-Naphthyl)propan-2-amine hydrochloride, 1-(6-Methoxy-2-naphthyl)ethanamine hydrochloride, 2-(1-Adamantyl)propan-2-amine hydrochloride, (4-Biphenylylmethyl)methylamine hydrochloride, Bromhexine hydrochlorid, N-(2-Chloroethyl)dibenzylamine hydrochloride, 3,3′,5,5′-Tetramethylbenzidine dihydrochloride hydrate, 1-Pyrenemethylamine hydrochloride, N-Fmoc-ethylenediamine hydrobromide, Anisotropine methyl bromide, N-Fmoc-1,3-propanediamine hydrobromide, Orphenadrine hydrochloride, N,N-Dimethyl-1,4-phenylenediamine oxalate, N-Fmoc-1,4-butanediamine hydrobromide, N-Fmoc-cadaverine hydrobromide, Alverine citrate salt, N-Fmoc-1,6-hexanediamine hydrobromide, 3,4-Dibenzyloxyphenethylamine hydrochloride or a combination thereof.

8. The modified treatment fluid of claim 1, wherein the WEA is a glycol or glycol ether selected from the group consisting of simple glycols, polyethylene glycols, 1,3-diols, 1,4-diols, 1,5-diols, ethylene glycol ethers, propylene glycol ethers, diethylene glycol ethers, and di-propylene glycol ether.

9. The modified treatment fluid of claim 1, wherein the WEA is an amide selected from the group consisting of organic amides, sulfonamides, and phosphoramides.

10. The modified treatment fluid of claim 1, wherein the WEA is an aldehyde selected from the group consisting of formaldehyde, acetaldehyde, propionaldehyde, butyraldehyde, furfural, and benzaldehyde.

11. The modified treatment fluid of claim 1, further comprising a second surfactant, wherein the second surfactant is different from the first surfactant.

12. The modified treatment fluid of claim 11, wherein the second surfactant is nonionic, cationic, anionic, zwitterionic, or a combination thereof.

13. The modified treatment fluid of claim 1, wherein the first surfactant is nonionic and selected from the group consisting of alcohol oxylalkylates, alkyl phenol oxylalkylates, nonionic esters, castor oil alkoxylates, fatty acid alkoxylates, lauryl alcohol alkoxylates, nonylphenol alkoxylates, octylphenol alkoxylates, and tridecyl alcohol alkoxylate, derivatives thereof, and combinations thereof.

14. The modified treatment fluid of claim 1, wherein the first surfactant is cationic and selected from the group consisting of alkyl amines, alkyl amine salts, quaternary ammonium salts such as trimethyltallowammonium halides, amine oxides, alkyltrimethyl amines, triethyl amines, alkyldimethylbenzylamines, cetyltrimethylammonium bromide, alkyl dimethyl benzyl-ammonium chloride, trimethylcocoammonium chloride, derivatives thereof, and combinations thereof.

15. The modified treatment fluid of claim 1, wherein the first surfactant is anionic and selected from the group consisting of alkyl carboxylates, alkylether carboxylates, N-acylaminoacids, N-acylglutamates, N-acyl-polypeptides, alkylbenzenesulfonates, paraffinic sulfonates, α-olefinsulfonates, lignosulfates, derivatives of sulfosuccinates, polynapthylmethylsulfonates, alkyl sulfates, alkylethersulfates, C8 to C22 alkylethoxylate sulfate, alkylphenol ethoxylate sulfate or salts thereof, monoalkylphosphates, polyalkylphosphates, fatty acids, alkali salts of fatty acids, glyceride sulfates, sodium salts of fatty acids, soaps, derivatives thereof, and combinations thereof.

16. The modified treatment fluid of claim 1, wherein the first surfactant is zwitterionic and selected from the group consisting of dihydroxyl alkyl glycinate, alkyl ampho acetate, alkyl ampho propionate, alkyl betaine, alkyl amidopropyl betaine, alkylimino mono- or di-propionates derived from waxes, fats or oils, and combinations thereof.

17. The modified treatment fluid of claim 1, wherein the treatment fluid is an aqueous fluid, a non-aqueous fluid, or a combination thereof.

18. A method of forming a modified treatment fluid comprising:
combining a first surfactant, wherein the first surfactant is nonionic, cationic, anionic, zwitterionic, or a combination thereof with a wettability altering additive (WEA), wherein the WEA is an additive or additives that alters the wetted state of a reservoir from oil-wet or weakly oil-wet to water-wet or weakly water-wet, and a treatment fluid.

19. The method of claim 18, wherein the modified treatment fluid is formed in-situ or ex-situ.

20. A method of recovering oil from a formation comprising:
forming a modified treatment fluid, wherein the modified treatment fluid comprises a wettability altering additive (WEA), a first surfactant, and a treatment fluid; and
introducing the modified treatment fluid into at least a portion of a subterranean reservoir.

21. The method of claim 20, wherein the modified treatment fluid is formed in-situ or ex-situ.

22. The method of claim 20, wherein the step of forming a modified treatment fluid comprises:
forming a mixture of the WEA and first surfactant ex-situ or partially ex-situ;
combining the mixture of the WEA and first surfactant with the treatment fluid in-situ.

23. The method of claim 20, wherein the method of recovering oil is performed in hydraulic fracturing treatments, water flooding treatments, polymer flooding treatments, re-fracs, re-pressurization, remediations, recompletions, acidizing treatments, or drilling.

24. The method of claim 20, wherein the treatment fluid further comprises an additive, the additive selected from the group consisting of salts, acids, proppant particulates, diverting agents, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, flocculants, additional H₂S scavengers, CO₂ scavengers, oxygen scavengers, lubricants, additional viscosifiers, breakers, weighting agents, relative permeability modifiers, resins, wetting agents, coating enhancement agents, filter cake removal agents, antifreeze agents, and combinations thereof.

25. The method of claim 20, wherein the modified treatment fluid is introduced into the subterranean formation through a wellbore.

26. The method of claim 20, wherein the functionality of the mixture of the first surfactant and WEA is performed using water solubility tests, emulsion tendency tests, interfacial surface tension measurements, wettability via contact angle, spontaneous imbibition tests, hydrocarbon recovery tests, adsorption tests, or a combination thereof.

27. A method for hydraulic fracturing comprising:
a. injecting a first amount of treatment fluid into a well without proppant, wherein the treatment fluid does not include proppant to initiate and propagate a fracture from the well while injecting a wettability altering additive (WEA) to form a treatment fluid/WEA blend, the WEA comprising an organic salt, an inorganic salt, urea, a urea derivative, a carbamate, ammonia, an amine, a glycol, a glycol ether, an amide, an aldehyde, or a combination thereof;
b. adding proppant to the treatment fluid/WEA/blend;
c. injecting a second amount of treatment fluid into the well while injecting a surfactant, wherein the surfactant is nonionic, cationic, anionic, zwitterionic, or a combination thereof, to form a modified treatment fluid within the well.
d. releasing the modified treatment fluid, formation water, and hydrocarbon into the well.

28. The method of claim 27, wherein the surfactant is injected into the well while adding proppant.

29. A method for hydraulic fracturing comprising:
a. injecting a first amount of treatment fluid into a well without proppant, a wettability altering additive (WEA), the WEA comprising an organic salt, an inorganic salt, urea, a urea derivative, a carbamate, ammonia, an amine, a glycol, a glycol ether, an amide, an aldehyde, or a combination thereof, and a surfactant, wherein the surfactant is nonionic, cationic, anionic, zwitterionic, or a combination thereof, wherein the treatment fluid does not include proppant, to initiate and propagate a fracture from the well;
b. adding a proppant to the first amount of treatment fluid together with additional WEA and surfactant;
c. injecting a second amount of treatment fluid, additional WEA, and additional surfactant.
d. releasing the treatment fluid, WEA, surfactant, formation water, and hydrocarbon into the well.
